(19) United States
(12) Patent Application Publication
(10) Pub. No.: US 2014/0208052 A1
(43) Pub. Date: Jul. 24, 2014

(54) ELECTRONIC DEVICE AND METHOD FOR PROTECTING MEMORY THEREOF

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: MING-YI CHEN, Shenzhen (CN); XIAO-YAN ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/159,399

(22) Filed: Jan. 20, 2014

(30) Foreign Application Priority Data
Jan. 24, 2013 (CN) 2013100264908

(51) Int. Cl. G06F 12/14

(52) U.S. Cl. CPC G06F 12/14
USPC 711/163

(57) ABSTRACT

An electronic device includes a memory, an addressing unit, a status determination unit, and a control unit. The memory unit stores a memory status parameter. The addressing unit is configured for addressing an address of the memory status parameter of the memory. The status determination unit is configured for determining a status of the memory according to a value at the addressed address. The status of the memory can be a read-only status or a writable status. The control unit is configured for modifying the value at the address of the memory status parameter to make the memory be in the read-only status when the memory is in the writable status

### 1. FIELD

The present disclosure relates to an electronic device and a method for protecting a memory of the electronic device.

### 2. BACKGROUND

A memory module of a computer device complying with the serial presence detect (SPD) standard stores SPD data in a non-volatile memory, such as an 8-pin serial read-only memory (ROM) or electronically erasable programmable read-only memory (EEPROM). During a startup process of the computer device, the basic input/output system (BIOS) of the host system addresses the SPD memory parameter, which indicates whether the memory is in a read-only status or a writable status, and configures the system based on the SPD memory parameter. However, if the SPD data are destroyed or maliciously modified, the BIOS cannot read the SPD data, which may cause problems for the host system.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an electronic device.

FIG. 2 is a flowchart of an embodiment of a method for protecting a memory of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

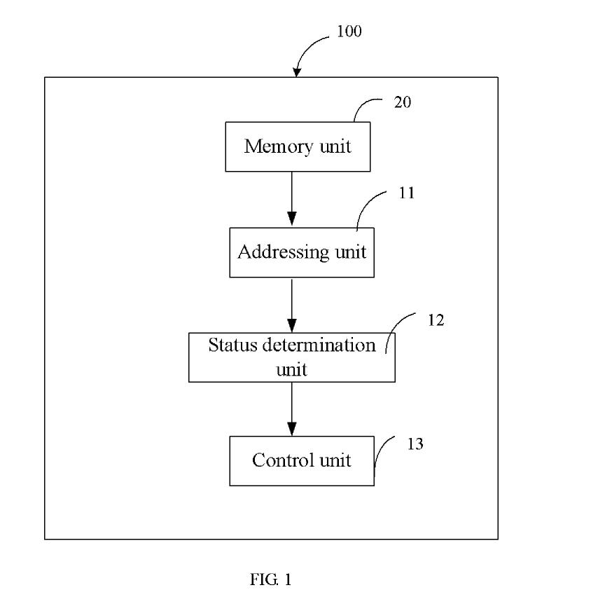

FIG. 1 shows an embodiment of an electronic device 100. The electronic device 100 includes an addressing unit 11, a status determination unit 12, a control unit 13, and a memory unit 20. The memory unit 20 stores a SPD memory parameter, which indicates a read-only/writable status of the memory unit 20 (hereinafter referred to as the “memory status parameter”). In the embodiment, the memory unit 20 is a system memory.

The addressing unit 11 is configured for locating an address of the memory status parameter of the memory unit 20. In the embodiment, the addressing unit 11 obtains the address of the memory status parameter from a system management bus (SMBUS) of the electronic device 100 during a startup process of a host system of the electronic device 10 and reads the value at the address.

The status determination unit 12 is configured for determining a status of the memory unit 20 according to the located address of the memory status parameter. The status of the memory unit 20 can be a read-only status or a writable status. In the embodiment, the status determination unit 12 determines the status of the memory unit 20 according to a value at the address of the memory status parameter. When the value at the address is a first value, the status determination unit 12 determines that the status of the memory unit 20 is the read-only status. When the value at the address is a second value, the status determination unit 12 determines that the status of the memory unit 20 is the writable status.

If the memory unit 20 is in the writable status, the control unit 13 modifies the value at the address of the memory status parameter to make the memory unit 20 be in the read-only status. In the embodiment, the control unit 13 generates a control signal and sends the generated control signal to a system management interrupt (SMI) of the electronic device 100. The SMI modifies the value at the address of the memory status parameter to make the memory unit 20 be in the read-only state when the control signal is received.

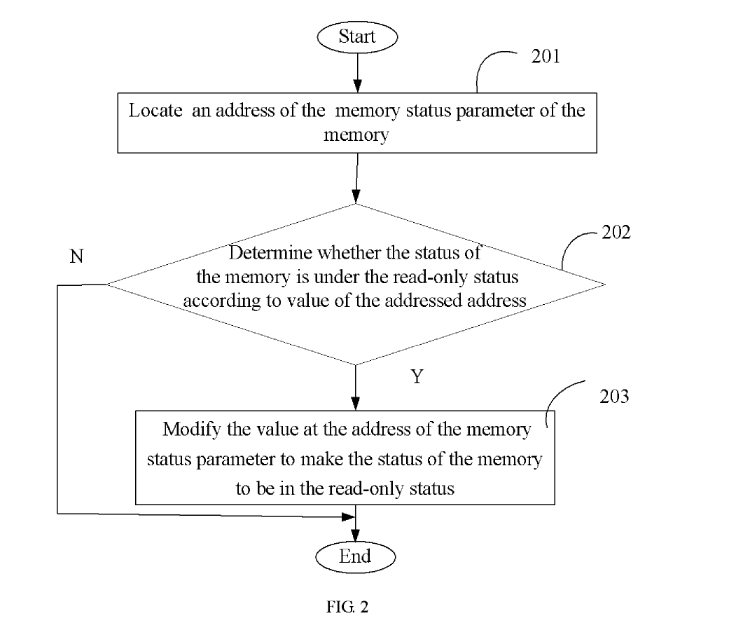

FIG. 2 shows a flowchart of a method for protecting the memory unit of the electronic device 100 of FIG. 1 from being modified. The method includes the following steps:

In step S201, the addressing unit 11 locates an address of the memory status parameter of the memory unit 20 from the SMBUS during a startup process of a host system of the electronic device 100.

In step S202, the status determination unit 12 determines whether a status of the memory unit 20 is in a read-only status according to the located address. If the memory unit is not in a read-only status, the process goes to step S203. Otherwise, the process ends.

In the embodiment, the status determination unit 12 determines the status of the memory unit 20 according to a value at the address of the memory status parameter. When the value at the address is a first value, the status determination unit 12 determines the status of the memory unit 20 is in the read-only status. When the value at the address is a second value, the status determination unit 12 determines the status of the memory unit 20 is in the writable status.

In step S203, the control unit 13 modifies the value at the address of the memory status parameter to make the memory unit 20 be in the read-only status.

In the embodiment, the control unit 13 generates a control signal and sends the generated control signal to a system management interrupt (SMI). The SMI modifies the value at the address of the memory status parameter to make the memory unit 20 be in the read-only status.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A method for protecting a memory of an electronic device, the memory storing a memory status parameter, the method comprising:
locating an address of the memory status parameter of the memory;
determining a status of the memory according to the value at the located address, the status of the memory being in a read-only status or a writable status;
modifying the value at the address of the memory status parameter to make the memory to be in the read-only status when the memory is in the writable status.

2. The method described as claim 1, wherein locating an address of a memory status parameter of the memory includes obtaining the address of the memory status parameter from a system management bus of the electronic device during a startup process of a host system the electronic device and reading the value at the addressed address.

3. The method described as claim 1, wherein determining a status of the memory according to the addressed address includes determining the status of the memory according to the value at the address of the memory status parameter.

4. The method described as claim 3, further comprising determining the status of the memory is in the read-only status when the value at the address is a first value.

5. The method described as claim 3, wherein determining the status of the memory is in the writable status when the value at the address is a second value.

6. An electronic device, comprising:
a memory storing memory status parameter;
an addressing unit, configured for locating the address of the memory status parameter of the memory;
a status determination unit, configured for determining a status of the memory according to the located address; the status of the memory being in a read-only status or a writable status;
a control unit, configured for modifying the value at the address of the memory status parameter to make the status of the memory to be in the read-only status when the status of the memory is in the writable status.

7. The electronic device as described in claim 6, wherein the addressing unit is configured for obtaining the address of the memory status parameter from a system management bus of the electronic device during a startup process of a host system of the electronic device and reading the value at the address.

8. The electronic device as described in claim 6, wherein the status determination unit determines the status of the memory according to the value at the address of the memory status parameter.

9. The electronic device as described in claim 8, the status determination unit determines the status of the memory is in the read-only status when the value at the address is a first value.

10. The electronic device as described in claim 8, the status determination unit determines the status of the memory is in the writable status when the value at the address is a second value.
